(19) United States
(12) Patent Application Publication
(10) Pub. No.: US 2026/0228912 A1
(43) Pub. Date: Aug. 6, 2026

(54) SYSTEMS AND METHODS FOR STORING, INTERROGATING AND/OR REFINING TEMPORAL SPATIAL INFORMATION

(71) Applicant: Visionary Machines Pty Ltd, Sydney, New South Wales (AU)

(72) Inventor: Rhys Andrew NEWMAN, Sydney (AU)

(73) Assignee: Visionary Machines Pty Ltd, Sydney, New South Wales (AU)

(21) Appl. No.: 19/150,739

(22) PCT Filed: Jan. 18, 2024
(86) PCT No.: PCT/AU2024/050026

§ 371 Date: Jul. 24, 2025

(30) Foreign Application Priority Data
Jan. 26, 2023 (AU) 2023900181

(51) Int. Cl. G06T 7/73; G06T 3/4038

(52) U.S. Cl. CPC G06T 7/74; G06T 3/4038; G06T 2207/30244

(57) ABSTRACT

The present disclosure is directed to devices, systems and/or methods that may be used for storage and retrieval of temporal spatial information captured with at least one spatial sensor. Exemplary embodiments may be used for determining scene information using data obtained at least in part from one or more cameras that move relative to the scene.

### FIELD

The present disclosure relates generally to devices, systems and/or methods that may be used for storing, querying, retrieving or updating scene information comprised of data obtained at least in part from one or more sensors. That scene information may be three-dimensional (3D) information.

### BACKGROUND

Scene information about the 3D environment is useful for many applications including, for example, the safe autonomous driving of vehicles, and for example, for navigation, surveying, environmental monitoring, crop monitoring, mine surveying, and/or checking the integrity of built structures. There are many digital storage technologies (e.g., database systems), some of which have been adapted to offer optimised access to geospatial data and, when time is also recorded this type of data may be termed temporal geospatial data. There are many choices of data schema in which to store temporal geospatial data, often depending on the expected use-case for the system, the typical structure of queries made of the data, and/or how the data is stored therein.

However, as errors are inherent in sensor outputs, such data may be subject to revision if a physically realistic and accurate representation of the 3D scene being sensed is sought. If the data is stored without refinement or is not combined to distil higher quality results, then the geospatial data returned in response to a query may retain the errors and noise characteristics of the original sensed data. Processing to refine and combine this raw data, especially if some of this data relates to substantially the same geospatial location, may produce a more refined and accurate representation of the 3D scene and, optionally, stored. Where this processing is achieved in advance of subsequent queries the system may consequently be able to respond more quickly than if no advance processing had been performed. However, such processing may be expensive and time consuming, so it may be a challenge to efficiently reprocess and recombine data when new information becomes available (for example, from new sensor readings). As a result, many temporal geospatial storage and retrieval systems have to choose between fast access to raw but potentially low-quality data, and slow access to processed high-quality data.

The present disclosure is directed to overcome and/or ameliorate at least one or more of the disadvantages of the prior art, as will become apparent from the discussion herein. The present disclosure also provides other advantages and/or improvements as discussed herein.

### SUMMARY

This summary is not intended to be limiting as to the embodiments disclosed herein and other embodiments are disclosed in this specification. In addition, limitations of one embodiment may be combined with limitations of other embodiments to form additional embodiments.

At least one embodiment is directed to a system for storing temporal spatial information comprising:
at least one camera array comprising at least one camera and one or more processors; wherein the at least one camera array and the one or more processors are configured to; generate a plurality of instances of spatial information instance data, identify in the plurality of instances one or more anchor points, at least one anchor point being in common between at least two separate instances, and store a plurality of instances together with identified anchor points.

A method for storing temporal spatial information comprising:
at least one camera array comprising at least one camera and one or more processors;
receiving one or more images at the at least one camera of the at least one camera array and transferring the one or more images to the one or more processors;
generating a plurality of instances of spatial information instance data based at least in part on the received one or more images at the one or more processors;
identifying in the plurality of instances one or more anchor points using one or more processors, wherein at least one anchor point being in common between at least two separate instances; and
storing a plurality of instances together with identified anchor points within at least one storage unit.

At least one embodiment is directed to devices, methods and/or systems comprising: at least one sensor; wherein the sensor is configured to generate spatial information instance data acquired at a plurality of locations and/or times; a one or more processors that is/are configured to accept a plurality of spatial information instance data from one or more sensors; that data constructed to allow the inclusion of one or more selected points (herein termed anchor points) from the scene; and provide access to data via a query interface that enables the selection of instance data based on selection criteria that may include a supplied 3D bounds and time range of interest.

At least one embodiment, is directed to devices, methods and/or systems comprising: at least one sensor; wherein the sensor is configured to generate spatial information instance data acquired at a plurality of locations and/or times; one or more processors that is/are configured to accept a plurality of spatial information instance data from one or more sensors; that data constructed to allow the inclusion of one or more anchor points from the scene; and provide access to such data via a query interface that enables the selection of instance data based on selection criteria that may include 3D bounds and time range; and the one or more processors is/are configured to respond to request for data (that specifies selection criteria that may include 3D physical bounds limitation and time range limitation), and on retrieval of that data (potentially containing anchor points) to align and combine the spatial information and provide a refined spatial information data set.

Certain embodiments are to a method for storing, interrogating and refining temporal geospatial data using any of the systems disclosed herein.

Certain embodiments are directed to one or more computer-readable non-transitory storage media embodying software that is operable when executed using any of the systems and/or methods disclosed herein.

The present disclosure is directed to overcome and/or ameliorate at least one or more of the disadvantages of the prior art, as will become apparent from the discussion herein. The present disclosure also provides other advantages and/or improvements as discussed herein.

### BRIEF DESCRIPTION OF DRAWINGS

Exemplary embodiments will now be described, by way of example only, with reference to the accompanying drawings.

FIG. 1 shows a representation of the process flow, according to at least one embodiment. Following raw data ingestion (flow from 110 downwards) one or more processors may align data and store the alignment together with raw data in the store (170). One or more processors may query the data (130), receiving suitable results from the store 170 via a query interface 135. If additional data and/or data revisions are received (180) the system may distil the results into a combined and refined model (190), may combine this with existing data from the store (170) and may save these combined results in the store (170).

FIG. 2 is a top-level system diagram for capturing and storing scene information and for then operating on data to incorporate updates, according to at least one embodiment disclosed herein. The exemplary system illustrated includes a camera array and a processing engine, according to at least one embodiment.

FIG. 3 is an illustration of exemplary uses and possible camera array configurations, according to at least one embodiment.

FIG. 4 is an illustration of exemplary camera array configurations, according to certain embodiments.

FIG. 5 shows an example of how the system may operate, according to at least one embodiment. A sensor path 530 is shown in box A, and again in box B after the sensor path has been adjusted to 550 so that the path to finishes at location 520b rather than 520.

FIG. 6 shows an example of how a system may rank locations along a path in order of pose certainty as a way of distributing incremental updates along a path when required by new information that may become available, according to at least one embodiment.

### DETAILED DESCRIPTION

The following description is provided in relation to several embodiments that may share common characteristics and features. It is to be understood that one or more features of one embodiment may be combined with one or more features of other embodiments. In addition, a single feature or combination of features in certain of the embodiments may constitute additional embodiments. Specific structural and functional details disclosed herein are not to be interpreted as limiting, but merely as a representative basis for teaching one skilled in the art to variously employ the disclosed embodiments and variations of those embodiments.

The subject headings used in the detailed description are included only for the ease of reference of the reader and should not be used to limit the subject matter found throughout the disclosure or the claims. The subject headings should not be used in construing the scope of the claims or the claim limitations.

Certain embodiments of this disclosure may be useful in several areas. For example, one or more of the following non-limiting exemplary applications: off-road vehicle (e.g., cars, buses, motorcycles, trucks, tractors, forklifts, cranes, backhoes, bulldozers); road vehicles (e.g., cars, buses, motorcycles, trucks); rail based vehicles (e.g., locomotives); air based vehicles (e.g., airplanes, drones), space based vehicles (e.g., satellites, or constellations of satellites); individuals (e.g., miners, soldiers, war fighters, rescuers, maintenance workers) , amphibious vehicles (e.g., boats, cars, buses) ; and/or watercraft (e.g., ships boats, hovercraft, submarines). In addition, the non-limiting exemplary applications may be operator driven, semi-autonomous and/or autonomous. Further applications may include navigation, autonomous vehicle navigation, surveying, surveillance, reconnaissance, intelligence gathering, environmental monitoring, and/or infrastructure monitoring.

The term “scene” means a subset of the three dimensional real-world (i.e., 3D physical reality) as perceived through the field of view of one or more cameras or other sensors. In certain embodiments, there may be at least 1, 2, 3, 4, 5, 10, 15, 20, 25, 30, 35 or 40, 100, 1000, or more cameras and or other sensors. In certain embodiments, there may be 3 to 8 cameras. In certain embodiments, there may be at least 3 to 8 cameras. In certain embodiments, there may be between 1 to 3 cameras, between 3 to 5 cameras, between 5 to 10 cameras, between 10 to 20 cameras, between 20 to 40 cameras between 40 to 100 cameras, or between 100 to 1000 cameras.

The term “object” means an element in a scene. For example, a scene may include one or more of the following objects: a person, a child, a car, a truck, a crane, a mining truck, a bus, a train, a motorcycle, a wheel, a patch of grass, a bush, a tree, a branch, a leaf, a rock, a hill, a cliff, a river, a road, a marking on the road, a depression in a road surface, a snow flake, a house, an office building, an industrial building, a tower, a bridge, an aqueduct, a bird, a flying bird, a runway, an airplane, a helicopter, door, a door knob, a shelf, a storage rack, a fork lift, a box, a building, an airfield, a town or city, a river, a mountain range, a field, a jungle, and/or a container. An object may be a moving element or may be stationary or substantially stationary. An object may be considered to be in a background or a foreground.

The term “physical surface” means the surface of an object in a scene that emits and/or reflects electromagnetic signals in at least one portion of the electromagnetic spectrum and where at least a portion of such signals travel across at least a portion of the scene.

The term “3D point” means a representation of the location of a point in the scene defined at least in part by at least three parameters that indicate distance in three dimensions from an origin reference to the point, for example, in three directions from the origin where the directions may be substantially perpendicular (at least not co-planar or co-linear), or as an alternative example using a spherical coordinate system consisting of a radial distance, a polar angle, and an azimuthal angle.

The term “3D surface” means a digital representation of a physical surface to a known degree of accuracy. One example may be a list of 3D points that collectively describe a triangular mesh. Another example may be a collection of well-known geometric shapes such as cuboids, ellipsoids, spheres or cylinders that together may represent a physical surface to a required degree of precision in 3D.

The term “camera” means a device that comprises an image sensor, an optional filter array and a lens (or a plurality of lenses) that at least partially directs a potentially limited portion of incoming electromagnetic signals onto at least some of the sensor elements in an image sensor. The lens, for example, may be a pin hole, an optical lens, a diffractive grating lens or combinations thereof. In certain embodiments a camera may be an imaging device that can image from electromagnetic signals in one or more bands including for example visible, ultraviolet, infra-red, or short-wave infra-red (SWIR).

The term “each” as used herein means that at least 95%, 96%, 97%, 98%, 99% or 100% of the items or functions referred to perform as indicated. Exemplary items or functions include, but are not limited to, one or more of the following: location(s), image pair(s), cell(s), pixel(s), pixel location(s), layer(s), element(s), neighbourhood(s), point(s), 3D neighbourhood(s), anchor points and 3D point(s).

The term “a substantial portion” as used herein means that at least 80%, 85%, 95%, 96%, 97%, 98%, 99%, or 100% of the items or functions referred to. Exemplary items or functions include, but are not limited to, one or more of the following: location(s), image pair(s), cell(s), pixel(s), pixel location(s), layer(s), element(s), point(s), neighbourhood(s), 3D neighbourhood(s), anchor points and 3D point(s).

The term “substantial” or “substantially” as used herein means that at least 80%, 85%, 95%, 96%, 97%, 98%, 99%, or 100% of the items or functions referred to.

The term “pose” means the location and orientation of an object, surface, sensor, collection of sensors, or information instance. The location and orientation may be described by a set of parameters and the set of parameters used may depend on the coordinate system being used. For example, in a cartesian coordinate system the parameters may comprise six numbers, three for the location being described by X, Y, X coordinates and three being for the orientation being described by rotation angle from the reference axis for pan, tilt, roll. The pose may be described by rotation and translation transformations from an origin. The rotation and translation transforms may be represented in a matrix.

The term “pose change” means the change in the location and orientation of an object, surface, sensor, collection of sensors. or information instance relative to some known reference pose. The pose change may be described by rotation and translation transformations. The rotation and translation transforms may be represented as a matrix.

The term “3D neighbourhood” means a 3D volume in the scene whose maximum linear extent in one or more directions is limited to be less than a specified threshold. That threshold, which may be different for different directions, may be, for example, about 0.1 mm, 1 mm, 5 mm, 1 cm, 5 cm, 10 cm, 50 cm, 1 m, 5 m, 10 m, 50 m, 100 m, or other value of appropriate scale when considering the overall size of the physical space represented by the scene. That threshold, which may be different for different directions, also may be, for example, between 0.1 mm to 5 mm, between 1 mm to 1 cm, between 1 cm to 10 cm, between 10 cm to 1 m, between 1 m to 10 m, between 10 m to 100 m, or other value of appropriate scale when considering the overall size of the physical space represented by the scene. A 3D neighbourhood may be considered to contain one or more 3D points if the coordinates of those points lie within the 3D volume described by that 3D neighbourhood. Discussion and/or calculations that refer to 3D neighbourhoods in the present disclosure may apply to single 3D points.

The terms “spatial information” means computer readable (i.e., digital) information regarding at least some of the 3D points, potentially overlapping 3D neighbourhoods and/or 3D surfaces that comprise the scene. For none, one or more of the 3D points, 3D neighbourhoods and 3D surfaces the spatial information may include none or one or more of:
i) a location of the 3D point, 3D neighbourhood or 3D surface (e.g., in the case of a 3D neighbourhood or 3D surface, a representative point of the 3D points contained therein or thereon, for example, the arithmetic and/or geometric centroid); ii) the spectral information regarding the appearance of the 3D point or one or more points contained in the 3D neighbourhood or on the 3D surface as viewed from the viewpoint of one or more cameras;
and iii) a set of metadata associated, at least in part, with the 3D point or at least some of the 3D points in the neighbourhood or on the 3D surface. The set of metadata may include one or more of the following properties: the texture of the points; spectral data from a region including or near the points; the instantaneous velocities of one or more points in one, two, or three dimensions (also allowing for one or more summarized velocity values such as the average velocity of the points in one, two, or three dimensions); the type or classification of objects wholly or partially present at the 3D point, in the 3D neighbourhood, on the 3D surface;
and potentially other associated data.

The term “relatively static time period” means a period of time in which the majority of the physical surfaces in a scene are at least substantially stationary relative to the camera. As used with respect to this term, the period of time may be about 0.0001 seconds, 0.01 seconds, 0.05 seconds, 0.1 seconds, 0.2 seconds, 1 second, or 10 seconds. As used with respect to this term, the period of time may be less than 0.0001 seconds, 0.01, 0.05, 0.1 seconds, 0.2 seconds, 1 second, 10 seconds or longer if appropriate to the situation. As used with respect to this term, the period of time may be between 0.0001 seconds and 10 seconds, 0.0001 seconds and 0.01 seconds, 0.01 seconds and 1 second, 0.05 seconds and 5 seconds, 0.1 seconds and 1 second, 0.2 seconds and 2 seconds, 1 second and 4 seconds, or 0.1 seconds and 10 seconds, or larger ranges as appropriate to the situation. As used with respect to this term, the period may be 1 minute, 10 minutes, 100 minutes or longer as appropriate when distances in the scene and/or speeds of objects or cameras are large enough (for example, in satellite and/or space-based applications).

The term “spatial information instance” means spatial information about a scene during a relatively static time period. A lidar and/or a camera array spatial sensor may deliver a spatial information instance. A spatial information instance may have a pose. A pose of the spatial information instance may be the pose of the spatial sensor that captured the spatial information from which the instance was generated.

The term “accumulated spatial information” means spatial information generated by the transformation and combination of at least a portion of data from two or more spatial information instances. Suitable transforms, for example, pose change, may be applied to none, one or more of the at least a portion of the data from the two or more special information instances that may ensure alignment of the spatial information instances to a common frame of reference.

The term “anchor point” means a specific 3D point that is identified, according to specific criteria that distinguish it from other points in the scene, within a spatial information instance and which may have a label associated with it; that label may be unique. An anchor point may be an identifiable feature in the scene when imaged by a camera; for example, a pole, corner of a street sign, edge of a building, tail-light of a vehicle. An anchor point may be identified on an object in the scene that is stationary or moving relative to the sensor, which itself may be stationary or moving.

The term “path” means the set of locations in a scene that an object (that may be a vehicle or a sensor and/or other object) passes through over a period of time. That time period may be about 0.1 sec, 1 sec, 10 secs, 100 secs, 1 mins, 2 mins, 5 mins, 10 mins, 1 hr, 2 hrs or other duration appropriate to a specific application or set of circumstances. That time period also may be between 0.1 sec to 1 sec, between 1 sec to 10 secs, between 10 sec to 100 secs, between 100 secs to 1 mins, between 1 mins to 10 mins, between 10 mins to 1 hr, between 1 hr to 2 hrs, or other duration appropriate to a specific application or set of circumstances. For example, the 3D positions of a camera or cameras mounted on a vehicle, measured and recorded over time while the vehicle moves through a scene. A path may be described by a set of in locations in three-dimensional space or by a set of locations on two-dimensional surface; for example, a line representing a road winding its way around a conventional 2D map.

The term “sensor path” means a path through a scene taken by a sensor or collection of sensors.

The term “geospatial temporal information” means spatial information with optional information that provides an association between the spatial information and one or more times or actual physical locations. The optional information may be, for example, the time a sensor recorded the data from the scene, or the latitude & longitude on the earth's surface of the sensor or objects in the scene at various times when the sensor samples the scene. Further examples of optional information may include one or more of the following non-limiting examples: temperature, wind speed, tide height and/or range, labels of interest (e.g., an annotation on the map labelled “dangerous to loiter”), and historical notes (place of battle, execution etc). Other suitable optional information is also contemplated.

The term “accumulated geospatial temporal information” means accumulated spatial information with optional information that provides an association between the accumulated spatial information and one or more times or actual physical locations.

The term “primary key” is an attribute of an element of a list or collection of data tuples and/or sets that uniquely identifies a set and/or data tuple within the list or collection of data tuples/sets. Database systems may rely on the existence of a primary key to build indexes into the list or collection.

The term “real-time” means processing may be sufficiently fast that resulting information may be used for making decisions at the time of operation or substantially at the time of operation. Non-limiting examples may be for applications on one or more of the following: a car, a truck, a train, an airplane, a helicopter, a drone, a satellite, a tractor, a ship, mobile farm or mining equipment, a fixed crane or observation point (e.g., security viewpoint) or a boat where real-time processing may be processing that is performed within 100 minutes, 10 minutes, 1 minute, 1 second, 100 ms, 10 ms, 1 ms or other value appropriate to the situation. Real-time processing also may be processing that is performed between 100 minutes to 10 minutes, between 10 minutes to I minute, between 1 minute to 1 second, between 1 second to 100 ms, between 100 ms to 10 ms, between 10 ms to 1 ms or other value appropriate to the situation.

### Main Flow

Spatial sensors of various types sample information about the 3D physical world to various degrees of accuracy, and it may be expected that errors may be present in the resulting data to some degree. Further, sensors may be mounted on moving platforms (e.g., cars, drones, planes, boats, and/or people) such that over time the 3D information captured forms a gradually evolving picture of a larger amount of the world than would be possible using a stationary sensor. In such cases the 3D information is subject to additional positional uncertainty beyond that of sensors' normal measurement errors, as the reference location from which the sensor captured one or more samples of the scene is also subject to measurement uncertainty.

Data management systems often need a constant reference point or points to make it possible to perform efficient and quick queries, especially if there is a large amount of data to manage. Such reference information is known in the art as a “primary key” within a data schema. While a geospatial data management system might use physical location (for example, identified by latitude and longitude) as a primary key, the inherent uncertainty in these measurements presents a range of challenges. Such a system may struggle to maintain a correct index when the physical location of measurements, or other 3D aspects of a scene are updated by better processing or by the addition of new or updated information.

A temporal geospatial data management system may use time as the main reference point instead. Measuring time may be accomplished in a distributed way using precision electronic clocks-suitably synchronised to an agreed source at one or more times before or during operation. While timing systems may suffer drift and errors too, these may be limited to within a few seconds over many months or even years. Furthermore, it may be that the vast majority of the 3D physical world does not change significantly over a period of a few seconds, and in that common case a timing error about when the sensor captured details about the (mostly static) environment may have minimal consequences.

Another requirement for a data management system is the ability to uniquely identify data and be able to retrieve it when required. If a large number of sensors are using the data management system simultaneously, time alone may not be sufficient to identify some sensed data uniquely. Thus, the main reference for data stored may have additional information beyond the simple timestamp generated by the sensor when the information was captured. One example of such additional disambiguating information is to associate a unique ID of the sensor with the timestamp of any data emitted from it. The data management system may therefore use this (ID, Time) pair to identify data samples, and as this information may not be mutable it may be well suited to use it as the primary key and may generate at least one index based on it.

With the primary indexing performed as above, there is less of a need to require the 3D position of data samples to be fixed. Indeed, it may be expected that over time the locations of one or more sensor data reference points may require updating because more accurate or more complete information about the 3D physical world becomes available. When a position is updated, there is often an implied requirement to update other positions too, for example, those positions adjacent to the one updated.

For example, a sensor may take 1000 3D scene information samples of a mostly straight road along a 1 km stretch, with each measurement representing approximately 1 m of distance travelled in a mostly forwards direction. Accumulating these samples together into a summary representation of the full 1 km section may make it possible to estimate the latitude & longitude of the end of the road given the latitude & longitude of the start of the road. Further in this example, at some later time, the latitude and longitude of the end of this stretch of road may be updated using a new source of information, so it may be desirable to update the positions of the other 1000 intermediate samples so that they still represent realistic incremental steps from the start of the road (still in its originally estimated latitude & longitude position) to the updated position of the end of the road.

Making a series of incremental adjustments of this nature has been studied in the art and is known as “rotational averaging”. There are a range of solutions to this problem, but without taking into account the 3D physical structures that exist along the path under consideration significant mistakes in aligning adjacent sensor samples may occur. Considering the example above, imagine the case where only one intermediate location amongst the 1000 samples suffers a serious misalignment with other samples being almost perfectly aligned. This situation is relatively common, where a brief environmental effect corrupts a single sensor reading (or equally makes a sensor reading unavailable), and therefore sensor alignment processing may be locally and/or briefly inaccurate. For example, one environmental event, in the case of a camera-based sensor, may be when the camera is briefly blinded by the sun. Equally a LIDAR sensor may receive a sudden wave of spurious reflections from water droplets splashed up from the road. In such cases, a position correction at the end of a stretch of road may be traced back and most of the required adjustments (particularly to pose) to the 1000 intermediate locations may be at this single bad location (the rest of the locations merely shifted to line up with the start and end locations).

The discussion herein illustrates why a correction methodology to intermediate locations as a result of relatively sparse but updated location estimates becoming available may find it useful to consider the detailed sensor data of these and/or other intermediate locations. However, examining such data may be expensive and slow. To address this, consider in the case of a camera-based sensor that there may be some features on objects and/or surfaces in the scene that are readily identifiable in one or more captured image frames automatically and/or unambiguously (for example, by applying one or more feature detection algorithms that are known in the art to the captured image frames of the scene). For example, such features may have strong contrast changes over a short physical extent and may be substantially planar and relatively small so that, particularly from a reasonable distance away, they may be reliably considered fixed points in the scene. If due to these properties such features may be identified in multiple frames of a camera-based sensor as it moves through the scene then such a point may act as a link between frames. Such points will be termed “anchor points”. A minimum of 3 anchor points identified in at least two frames may be required to uniquely constrain the movement of the camera-based sensor in 3D space, and from these at least 3 links between frames the 6-dimensional movements (i.e., the pose changes) of the camera-based sensor as it traverses its path through scene may be determined. In certain embodiments, a minimum of about 3, 5, 6, 7, 8 10, 15, 20, 50, 100 or more anchor points identified in at least two frames may be required to constrain the movement of the camera-based sensor in 3D space. In certain embodiments, a minimum of between 3 to 6, between 6 to 8, between 8 to 10, between 10 to 20, between 20 to 50, between 50 to 100, or more anchor points identified in at least two frames may be required to constrain the movement of the camera-based sensor in 3D space.

However, it may be that anchor points are known only to some limit of accuracy. Nevertheless, there is a significant advantage, in terms of storage space, retrieval time and processing overhead if only a handful of such anchor points are examined per frame rather than a larger portion of the sensor data captured per frame. For example, anchor points may make of less than 0.001%, 0.01%, 0.1%, 1% or 10% of the sensor data captured per frame. For example, anchor points also may make between 0.001% to 0.01%, between 0.01% to 0.1%, between 0.1% to 1%, between 1% to 10% of the sensor data captured per frame. At a minimum, if only 3 such points are recorded for each frame, a realignment process may be able to use just this information to update intermediate locations and poses, rather than retrieve potentially many millions of points that a camera-based sensor is capable of capturing per frame. Between pairs of frames from a camera-based sensor it is possible to define a ranking of image location matching between them, ordered according to levels of matching accuracy and/or certainty. The top ranked (i.e., closest or best matched) points, recorded and marked together with their associated measures of their matching accuracy and/or certainty may be suitable anchor points. Note that although only 3 anchor points (in at least two frames) may be minimally required to recover the unique pose change, more than this may be desirable to ensure that enough anchor points are correctly identified on the static background of the 3D physical scene rather than on other objects that are moving independently of either the background or sensor. For example, in a typical road environment there may be many other moving cars, trucks, cycles, etc., and calculating sensor motion based on anchor points identified on these objects may result in incorrect pose changes in some applications.

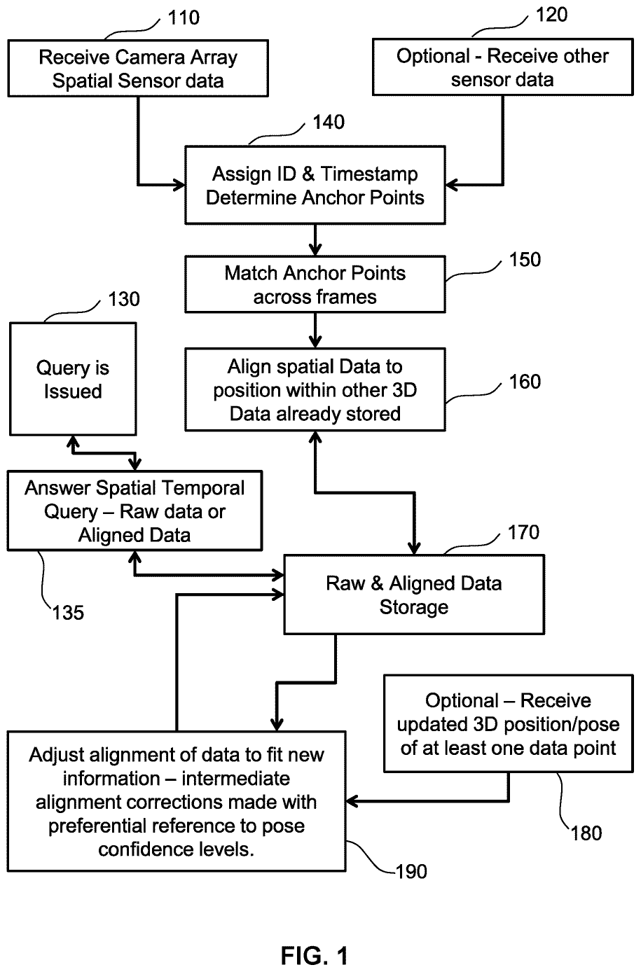

As illustrated in FIG. 1, the exemplary system receives sensor data from a camera array 110 (as well as optional additional sensor data 120) and prepares to store the sensor data into a store 170 using a unique pair of (sensorID, timestamp) values as a primary key. The next phase 140 identifies a number of suitable anchor points in the image frames, and matching some of these points between frames to provide a link between frames of sensor data occurs at step 150. The current pose of the sensor may now be estimated, optionally aligned to other data already stored (160), and the results may be stored at 170. Consequently, because the pose alignment computations between frames (e.g., at 160) may now focus on potentially as few as three anchor points, the sensor's pose changes may be estimated in real-time, or substantially real-time, even in certain embodiments on demand (i.e., when a query is received from an external system 130 and the stored data in 170 is searched by a query processing system 135). When subsequent pose information comes to light 180, it may require an overall adjustment to a sensor path but may only identify pose information for a portion of the locations along the sensor path. Therefore, interpolating poses of some intermediate sensor locations may be done to fill in the gaps that subsequent pose information lacks (shown at 190). In addition, the one or more processors may adjust pose information with respect to one or more locations based in least in part on the new pose information. The new pose information may alleviate the need for interpolation at one or more locations or be used in to determine an interpolation at one or more locations. These calculations may be based on the relatively few anchor points identified 140 and matched 150 and stored 170, so only a few items of data may be required to be retrieved from the store 170 to support the adjustment calculations 190. In certain embodiments, the locations with the largest uncertainty in their pose may be moved by the largest amount to account for the necessary overall change in sensor path locations, whereas locations that have low uncertainty in their pose may be moved the least, or not moved at all. In certain embodiments, the system may be configured to firstly rank the sensor locations based on their pose uncertainty (for example, largest to smallest or smallest to largest) to identify which locations are to be adjusted by a larger portion of an overall adjustment, and which are to be adjusted by a smaller or no portion of an overall adjustment. With fractions of the overall of adjustment to the sensor path now allocated to at least some of the locations along the path, the poses of the locations may now be updated in conjunction with the associated anchor points and the updated results may be stored at 170. In certain embodiments the fractional adjustments to pose may be determined in terms of the necessary adjustments to the anchor point positions, from which an updated sensor pose may be derived. Alternatively, in certain embodiments, the fractional adjustments to pose may be applied to the sensor poses directly and the position of associated anchor points updated as a consequence. Via these mechanisms the data management system may be able to update positional information of sensor data measurements in real-time, or substantially real-time, which may then be assembled into summary datasets as required, even on demand when a query 130 is received by the query processing system 135.

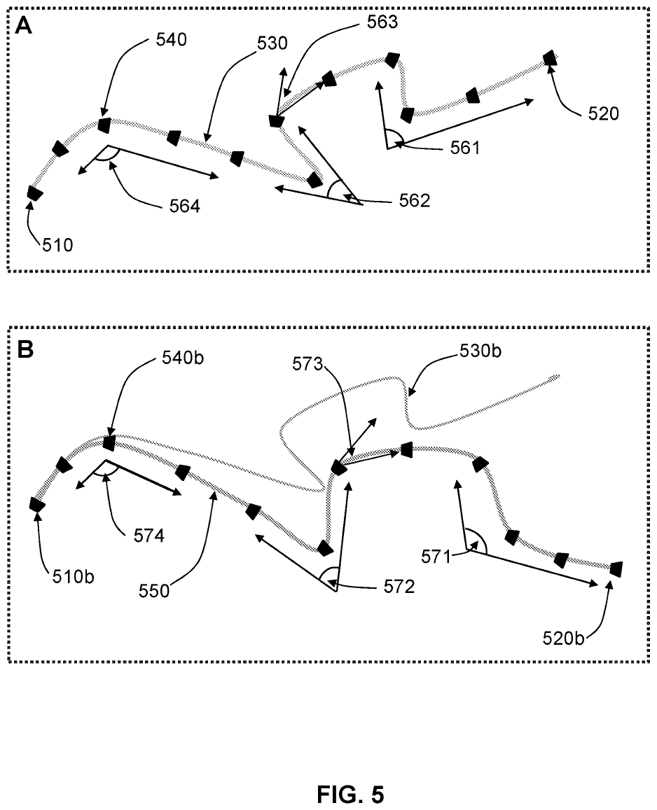

FIG. 5 illustrates the above procedure according to at least one embodiment, where a 2D representation of the path of a 3D scene sensor (540) is shown at a number of intermediate positions over time as it is moved along a path (shown as the line 530) from position 510 to position 520. The sensor captures 3D scene information at one or more of these intermediate positions (e.g., at 510, 540, 520). The system may then, in response to some new information that requires the end point 520 to be moved to 520b, update the one or more intermediate poses that had previously been recorded. In this example, the original path 530 (shown in box A, and again for reference in box B as 530b), has been adjusted by the system to 550. Path 550 starts at 510 and by incremental steps ends up at 520b (instead of 520 as was the case before the new end-point location was supplied). In this example, the intermediate poses have also been adjusted to align along path 550, but not necessarily all, or not substantially all, by the same amount. Along the path 530 some poses, such as those with angles 564 and 563, may be known to a high confidence level. In contrast some poses, such as those with angles 561 and 562, may be known to be less accurate. When the intermediate poses are adjusted alter 530 to 550, the high confidence poses may be left relatively unchanged (for example, 564 goes to 574, and 563 goes to 573), whereas poses with lower confidence are adjusted more (for example, 561 goes to 571, and 562 goes to 572).

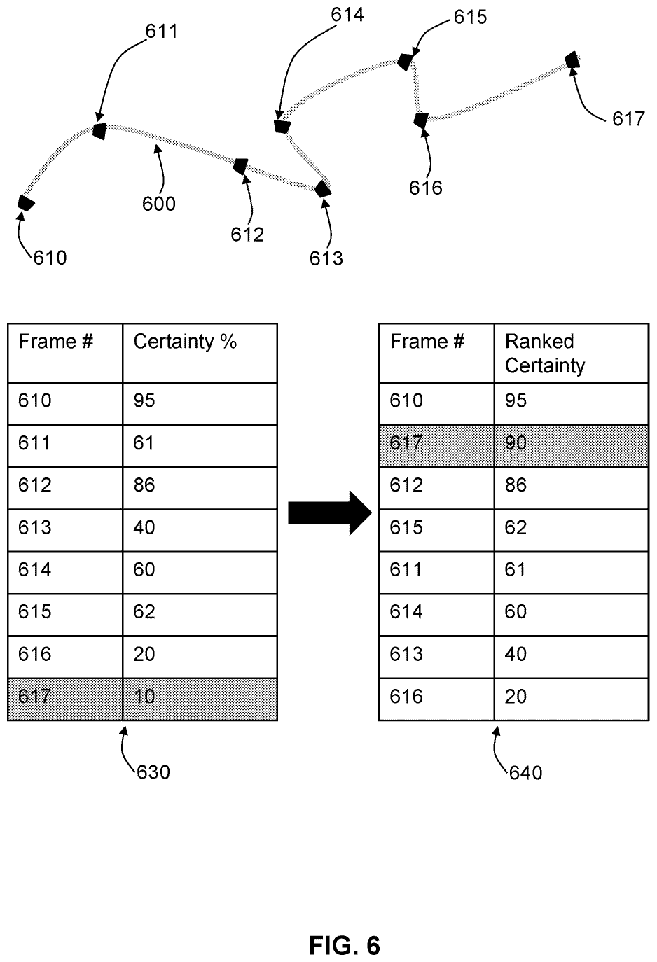

FIG. 6 illustrates and exemplary embodiment that firstly ranks sensor poses along a path in descending order of certainty as a way to determine the relative proportions of an overall update to a sensor path (600) should be applied at intermediate locations along the path. The sensor path 600 initially comprises the sensor poses 610, 611, 612, 613, 614, 615, 616, and 617 with calculated pose uncertainties shown as percentages in the table 630. Note how location 617 in table 630 shows a low confidence of 10%. A new measurement arrives from some external source that updates the pose of 617 with a higher confidence of 90%, as illustrated in table 640. The exemplary system, in this example, accepts this new information, and ranks the locations 610, 611, 612, 613, 614, 615, 616, and 617 in order of their uncertainties as shown in table 640. The overall update to the path that requires 617 to be in a new position is the distributed along the path as a series of incremental updates to the poses 610, 611, 612, 613, 614, 615, 616, and 617 with, for example, the incremental updates to poses 616, 613 and 614 being larger than the incremental updates to poses 610, 617 and 612.

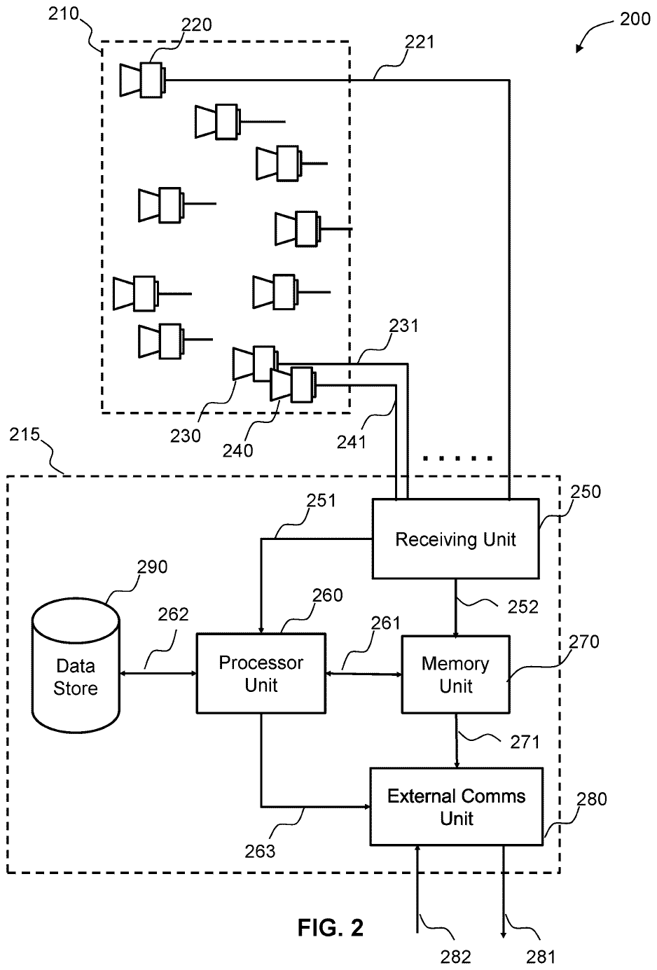

FIG. 2 shows a system diagram 200 of at least one embodiment. The system includes a sensor array 210 and one or more processors 215.

The sensor array 210 includes a set of depth sensors in a selected configuration In certain embodiments, the sensors array consists of a single type of depth sensor (e.g., ToF camera, lidar, radar). In certain embodiments, the sensor array consists a mixture of different types of depth sensor (e.g., RGB camera stereo pairs, near infrared camera stereo pairs, long-wave infrared stereo or multi-stereo sensor, lidar, radar). In certain embodiments, the sensor array may include related circuitry to ensure synchronised capture of data from a portion, a substantial portion of all of the depth sensors 210.

The one or more processors 215 includes a receiving unit 250 for communication with the depth sensors in the sensor array 210. The receiving unit is connected via communication bus 251 with the processor unit 260, and a memory unit 270. The processor unit 260 may be a general-purpose CPU or GPU or may be customised hardware such as an FPGA or ASIC designed to perform the required processing. The memory unit 270 may include volatile and/or non-volatile memory. It may store instructions for the processing unit 260 as well as image data received from the receiving unit 260 via the communications bus 252. The processing unit 260 may also be connected to a data store 290 via communications bus 262. The processing unit 260 may also be connected to (or in communication with) an external communications unit 280 via 263. The communications unit 280 may be used to output a 3D data stream for the use of external systems. The communications unit 280 may also receive data from external sources including position data, map data and/or previously recorded 3D data regarding the scene.

Depth sensors in the sensor array 210 may be connected to the one or more processors 115. Depth sensors have a communication channel indicated by 221, 231, 241 to accept control and/or synchronisation signals and to output depth data. Synchronous capture of images, point clouds, depth maps or other data from sensors in the depth sensor array 210 may be useful and may be enabled by the communication channel 221, 231, 241.

The one or more processors 215 may receive and may process data from depth sensors in the sensor array 210 to produce a number of depth maps. Some depth sensors, such as time-of-flight cameras may produce a depth map directly. Some depth sensors, such as LIDAR, may produce depth information as a point cloud, a series of 3D points set about the sensor, which may then be transformed into a depth map by projecting the 3D points towards the sensor centre and onto an assumed conceptual imaging plane in a manner similar to the idealised pin-hole camera model that is known in the art. Some depth sensors, such as stereo camera pairs, may produce depth maps generated though the principle of image stereo disparity. The techniques for producing depth maps from stereo camera pairs are known in the art and will not be described further.

The one or more processors 215 may store the depth maps in memory unit 270.

FIG. 2 shows an exemplary system (200). FIG. 2 includes an exemplary configuration of depth sensors 210 and an exemplary one or more processors (215). In certain embodiments, one or more processors perform one or more steps of one or more methods described or disclosed herein. In certain embodiments, one or more processors provide functionality described or shown in this disclosure. In certain embodiments, software configured to be executable running on one or more processors performs one or more steps of one or more methods disclosed herein and/or provides functionality disclosed herein. Reference to one or more processors may encompass a computing device, and vice versa, where appropriate.

This disclosure contemplates a suitable number of one or more processors. As example and not by way of limitation, one or more processors (215) may be an embedded one or more processors, a system-on-chip (SOC), a single-board one or more processors (SBC) (such as, for example, a computer-on-module (COM) or system-on-module (SOM)), a desktop one or more processors, a laptop or notebook one or more processors, a main-frame, a mesh of one or more processors, a personal digital assistant (PDA), a server, a tablet one or more processors, an augmented/virtual reality device, or a combination of thereof. Where appropriate, one or more processors (215) may include one or more processors; be unitary or distributed; span multiple locations; span multiple machines; span multiple data centres; or reside in a cloud, which may include one or more cloud components in one or more networks. Where appropriate, one or more one or more processors (215) may perform without substantial spatial or temporal limitation one or more steps of one or more methods described or illustrated herein. As an example, and not by way of limitation, one or more processors (215) may perform in real-time (or substantially real-time) or in batch mode one or more steps of one or more methods disclosed herein.

The one or more processors (215) may include a processor unit (260), memory unit (270), data storage (290), a receiving unit (250), and an external communication unit (280).

The processor unit (260) may include hardware for executing instructions, such as those making up a computer program. As an example, and not by way of limitation, to execute instructions, processor unit (260) may retrieve the instructions from an internal register, an internal cache, memory unit (270), or data storage (290); decode and execute them; and then write one or more results to an internal register, an internal cache (not shown), memory unit (270), or data storage (290). The processor unit (260) may include one or more internal caches for data, instructions, or addresses. This disclosure contemplates processor units (260) including a suitable number of suitable internal caches, where appropriate. The processor unit (260) may include one or more instruction caches, one or more data caches, and one or more translation lookaside buffers (TLBs). Instructions in the instruction caches may be copies of instructions in memory unit (270) or data storage (290), and the instruction caches may speed up retrieval of those instructions by processor unit (260).

The memory (270) may include main memory for storing instructions for processor to execute or data for processor to operate on. The one or more processors (215) may load instructions from data storage (290) or another source (such as, for example, another one or more processors) to memory unit (270). The processor unit (260) may then load the instructions from memory unit (270) to an internal register or internal cache. To execute the instructions, the processor unit (260) may retrieve the instructions from the internal register or internal cache and decode them. During or after execution of the instructions, the processor unit (260) may write one or more results (which may be intermediate or final results) to the internal register or internal cache. The processor unit (260) may then write one or more of those results to the memory unit (270). The processor unit (260) may execute only instructions in one or more internal registers or internal caches or in the memory unit (270) (as opposed to data storage (290) or elsewhere) and operates only on data in one or more internal registers or internal caches or in memory unit (270) (as opposed to data storage (290) or elsewhere). One or more memory buses may couple processor unit (260) to memory unit (270). The Bus (not shown) may include one or more memory buses. The memory unit (270) may include random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. Memory unit (270) may include one or more memories, where appropriate.

The data storage (290) may include mass storage for data or instructions. The data storage (290) may include a hard disk drive (HDD), flash memory, an optical disc, a magneto-optical disc, magnetic tape, or a Universal Serial Bus (USB) drive or a combination therein. Data storage (290) may include removable or non-removable (or fixed) media, where appropriate. Data storage (290) may be internal or external to one or more processors, where appropriate. Data storage may include read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination thereof.

In certain embodiments, I/O interface (not shown) may include hardware, software, or both, providing one or more interfaces for communication between one or more processors and one or more I/O devices. One or more processors may include one or more of these I/O devices, where appropriate. One or more of these I/O devices may enable communication between a person and one or more processors. An I/O device may include a keyboard, keypad, microphone, monitor, mouse, printer, scanner, speaker, still camera, stylus, tablet, touch screen, trackball, video camera, another suitable I/O device or a combination thereof. An I/O device may include one or more sensors. This disclosure contemplates any suitable I/O devices and any suitable I/O interfaces for them. Where appropriate, I/O interface may include one or more device or software drivers enabling the processor unit (160) to drive one or more of these I/O devices. I/O interface may include one or more I/O interfaces, where appropriate.

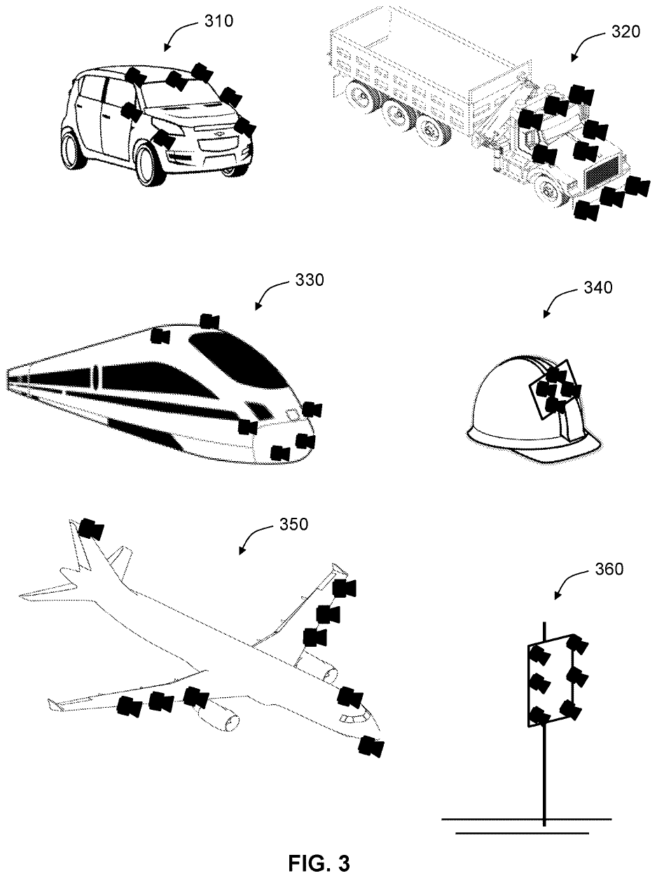

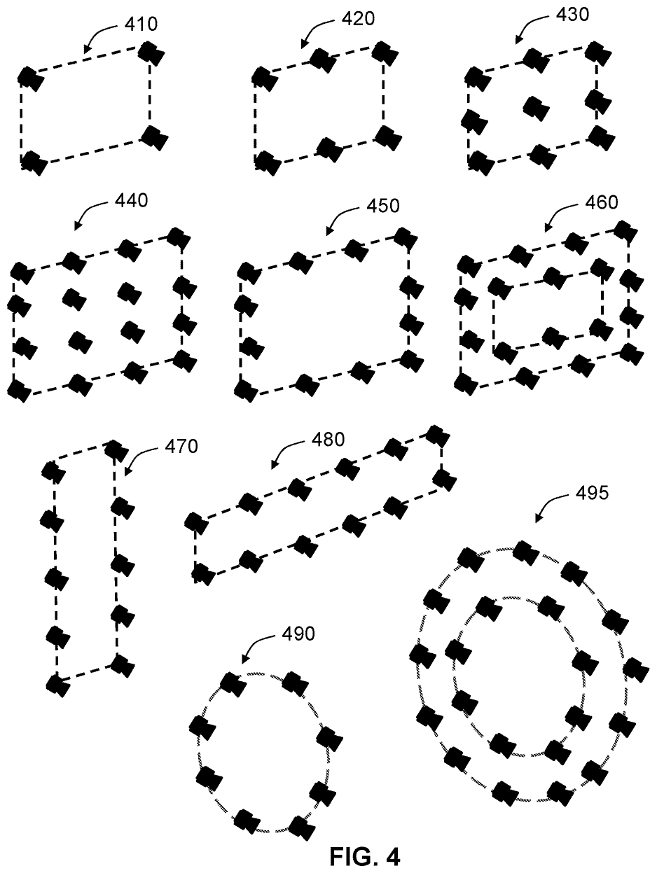

Although FIG. 2 shows an exemplary configuration of depth sensors other configurations may be used. For example, the sensors may be arranged in a circular pattern, a zigzagged pattern, a scattered pattern, and some of the sensors may be offset in one or more of the three dimensions. To illustrate, FIG. 3 shows depth sensors used in a variety of exemplary situations including on a car 310, on a truck 320, on a train 330, on a helmet 340, on an airplane 350 and on a post 360. And FIG. 4 shows depth sensors in further alternative exemplary configurations including 2×2 rectangle 410, 3×2 rectangle 820, 3×3 rectangle 830, 4×4 rectangle 840, hollow 4×4 rectangle 450, two concentric rectangles 460, a thin vertically posed array 470, a thin horizontally posed array 480, a circle 490, and concentric circles 495. In practice there are few limitations on the configuration of the depth sensors. Additionally, some depth sensors may move relative to each other on articulated parts of the base platform or vehicle. Further, depth sensors may be free to move independently (e.g., mounting one or more on one or more drones) and certain embodiments of this disclosure may still apply.

In addition to other advantages disclosed herein, one or more of the following advantages may be present in certain embodiments.

One advantage is that by storing un-processed (or minimally processed) spatial information, and leaving the optimal accumulation of such information into refined combined results until requested (i.e., on-demand processing or just-in-time processing), the system may more easily ensure a query of the data receives an up-to-date combined result even when aspects of the underlying data are being continuously, or substantially continuously, updated with additional data and/or data revisions. Even the 3D location of the sensor taking a sample view of the 3D scene may be subject to various sources of error, and there may be substantial utility to be gained by continuously, or substantially continuously, improving these positions' accuracy with additional processing, additional measurements from the scene if and when available, or a combination of both. A system that facilitates this flexibility by supporting an on-demand result generation, may be useful in a range of applications.

Another advantage may be that by observing the refined and/or combined output of such a system, an area and/or region of the world where significant error or confusion about the objects, structure or appearance of the scene may be identified and an action initiated to acquire new data from that location to explicitly resolve these problems and/or ambiguities. For example, it may be that even over several mapping passes down a one-way street the rear of a street-side cabinet may never be viewed directly from cameras mounted on vehicles. A separate task may be to send a person or robot that may travel on the pavement to that location to image the rear view of that cabinet.

Another advantage may be that additional sensor information may be associated with spatial information and/or time information and may be searched, filtered and/or accessed. Such additional information may be that derived merely with further processing, such as using methods to increase accuracy or to add labels from an object classification system. These additional annotations may then be attached to the raw data from which they are derived or associated, and thereby be located in at least one of the three spatial dimensions.

Another advantage is that new but sparse updates of sensor locations and/or poses may be ingested and intermediate location estimates between these new positions and/or pose estimates may be adjusted so that the most uncertain pose estimates are preferentially altered to accommodate the required overall path change(s) rather than disturbing those poses in the path(s) that are most certain. Adjusting intermediate poses in this way may reduce the often-significant errors that other rotational averaging methods may introduce by being insensitive to data context.

While certain embodiments have been shown and described herein, it will be obvious to those skilled in the art that such embodiments are provided by way of example only.

Further advantages and/or features of the claimed subject matter will become apparent from the following examples describing certain embodiments of the claimed subject matter.
1. A system for storing temporal spatial information comprising:
   at least one camera array comprising at least one camera and one or more processors; wherein the at least one camera array and the one or more processors are configured to; generate a plurality of instances of spatial information instance data, identify in the plurality of instances one or more anchor points, at least one anchor point being in common between at least two separate instances, and store a plurality of instances together with identified anchor points.
2. A system of example 1, wherein the system is further configured to determine one or more pose changes between at least two spatial information instances using the one or more anchor points common between the at least two spatial information instances.
3. A system of examples 1 or 2, wherein the system is further configured to use the determined pose changes to align two or more pairs of spatial information instances to generate an accumulated spatial information instance.
4. A system of example 3, wherein the system is further configured to store the accumulated spatial information instance.
5. The system of any of examples 1 to 4, wherein the accumulated spatial information instance is one or more of the following: larger, more complete, more detailed, and more accurate than at least one of the single spatial instances.
6. The system of any of examples 1 to 5, wherein temporal spatial information is geospatial temporal information.
7. The system of any of examples 1 to 6, wherein temporal spatial information is accumulated geospatial temporal information.
8. The system of any of examples 1-7, wherein the at least one camera is at least 1, 2, 3, 4, 5, 6, or 10 cameras.
9. The system of any of examples 1-8, wherein one or more poses in one or more spatial information instances is adjusted, in the light of further spatial or temporal spatial information becoming available, based on the degree of confidence associated with the one or more poses being adjusted.
10. The system of any of examples 1-10, wherein a sensor path comprises a series of pose changes determined by the one or more processors.
11. The system of any of examples 1 to 10, wherein the system is configured to continuously, or substantially continuously, accept additional data and/or data revisions in real-time or substantially real-time.
12. The system of example 11, wherein real-time is between 100 minutes to 10 minutes, between 10 minutes to I minute, or between 1 minute to 1 second.
13. The system of example 11, wherein real-time is between 1 second to 100 ms, between 100 ms to 10 ms, or between 10 ms to 1 ms.
14. The system of any of the examples 1 to 13, wherein the one or more processors is further configured to accept updates, corrections, additions, deletions or combinations thereof to the pose of one or more of the sensor locations, and by retrieving and, if needed, altering the selection or projected location of the one or more anchor points as viewed with the at least one camera in the camera array, and optionally updates one or more sensor poses.
15. The system of any of examples 1 to 14, wherein, the one or more processors is further configured to accept updates, corrections, additions, deletions or combinations thereof to the pose of the one or more of the sensor locations along the sensor path, ranks a portion of the sensor poses along the sensor path, according to the uncertainties in their pose; and applies larger pose adjustments to those locations with the greatest uncertainty in pose, and smaller or no pose adjustments to locations with the least uncertainty in pose.
16. A method for storing temporal geospatial information using any of the systems in examples 1-15.
17. One or more computer-readable non-transitory storage media embodying software that is operable when executed using any of the systems or methods in examples 1 to 15 and examples 18 to 32.
18. A method for storing temporal spatial information comprising:
at least one camera array comprising at least one camera and one or more processors;
receiving one or more images at the at least one camera of the at least one camera array and transferring the one or more images to the one or more processors;
generating a plurality of instances of spatial information instance data based at least in part on the received one or more images at the one or more processors;
identifying in the plurality of instances one or more anchor points using one or more processors, wherein at least one anchor point being in common between at least two separate instances; and storing a plurality of instances together with identified anchor points within at least one storage unit.
19. The method for storing temporal spatial information of example 18, wherein the method determines one or more pose changes between at least two spatial information instances using the one or more anchor points common between the at least two spatial information instances.
20. The method for storing temporal spatial information of examples 18 or 19, wherein the method uses the determined pose changes to align two or more pairs of spatial information instances to generate an accumulated spatial information instance.
21. The method for storing temporal spatial information of example 20, wherein the system is further configured to store the accumulated spatial information instance.
22. The method for storing temporal spatial information of any of examples 18 to 21, wherein the accumulated spatial information instance is one or more of the following: larger, more complete, more detailed, and more accurate than at least one of the single spatial instances.
23. The method for storing temporal spatial information of any of examples 18 to 22, wherein temporal spatial information is geospatial temporal information.
24. The method for storing temporal spatial information of any of examples 18 to 23, wherein temporal spatial information is accumulated geospatial temporal information.
25. The method for storing temporal spatial information of any of examples 18 to 24, wherein the at least one camera is at least 1, 2, 3, 4, 5, 6, or 10 cameras.
26. The method for storing temporal spatial information of any of examples 18 to 25, wherein one or more poses in one or more spatial information instances is adjusted, in the light of further spatial or temporal spatial information becoming available, based on the degree of confidence associated with the one or more poses being adjusted.
27. The method for storing temporal spatial information of any of examples 18 to 26, wherein a sensor path comprises a series of pose changes determined by the one or more processors.
28. The method for storing temporal spatial information of any of examples 18 to 27, wherein the system is configured to continuously, or substantially continuously, accept additional data and/or data revisions in real-time or substantially real-time.
29. The method for storing temporal spatial information of example 28, wherein real-time is between 100 minutes to 10 minutes, between 10 minutes to I minute, or between 1 minute to 1 second.
30. The method for storing temporal spatial information of example 28, wherein real-time is between 1 second to 100 ms, between 100 ms to 10 ms, or between 10 ms to 1 ms.
31. The method for storing temporal spatial information of any of examples 18 to 30, wherein the one or more processors accepts updates, corrections, additions, deletions or combinations thereof to the pose of one or more of the sensor locations, and by retrieving and, if needed, altering the selection or projected location of the one or more anchor points as viewed with the at least one camera in the camera array, and optionally updates one or more sensor poses.
32. The method for storing temporal spatial information of any of examples 18 to 31, wherein, the one or more processors accepts updates, corrections, additions, deletions or combinations thereof to the pose of the one or more of the sensor locations along the sensor path, ranks a portion of the sensor poses along the sensor path, according to the uncertainties in their pose; and applies larger pose adjustments to those locations with the greatest uncertainty in pose, and smaller or no pose adjustments to locations with the least uncertainty in pose.

In the foregoing description of certain embodiments, specific terminology has been resorted to for the sake of clarity. However, the disclosure is not intended to be limited to the specific terms so selected, and it is to be understood that a specific term includes other technical equivalents which operate in a similar manner to accomplish a similar technical purpose. Terms such as “left” and right”, “front” and “rear”, “above” and “below” and the like are used as words of convenience to provide reference points and are not to be construed as limiting terms.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

It is to be understood that the present disclosure is not limited to the disclosed embodiments, and is intended to cover various modifications and equivalent arrangements included within the spirit and scope of the present disclosure. Also, the various embodiments described above may be implemented in conjunction with other embodiments, e.g., aspects of one embodiment may be combined with aspects of another embodiment to realize yet other embodiments. Further, independent features of a given embodiment may constitute an additional embodiment.

1. A system for storing temporal spatial information comprising:
at least one camera array comprising at least one camera and one or more processors; wherein the at least one camera array and the one or more processors are configured to:
generate a plurality of instances of spatial information instance data,
identify in the plurality of instances one or more anchor points, at least one anchor point being common between at least two separate instances, and
store a plurality of instances together with identified anchor points.

2. The system of claim 1, wherein the system is further configured to determine one or more pose changes between at least two spatial information instances using the one or more anchor points common between the at least two spatial information instances.

3. The system of claim 2, wherein the system is further configured to use the determined one or more pose changes to align two or more pairs of spatial information instances to generate an accumulated spatial information instance.

4. The system of claim 3, wherein the system is further configured to store the accumulated spatial information instance.

5. The system of claim 3, wherein the accumulated spatial information instance is one or more of the following: larger, more complete, more detailed, and more accurate than at least one of a single spatial instances.

6. The system of claim 1, wherein the temporal spatial information is geospatial temporal information.

7. The system of claim 1, wherein the temporal spatial information is accumulated geospatial temporal information.

8. The system of claim 1, wherein the at least one camera array comprises at least 1, 2, 3, 4, 5, 6, or 10 cameras.

9. The system of claim 1, wherein one or more poses in one or more spatial information instances is adjusted, based on further spatial or temporal spatial information becoming available, based on a degree of confidence associated with the one or more poses being adjusted.

10. The system of claim 1, wherein a sensor path comprises a series of pose changes determined by the one or more processors.

11. The system of claim 1, wherein the system is configured to continuously, or substantially continuously, accept additional data and/or data revisions in real-time or substantially real-time.

12. The system of claim 11, wherein real-time is between 100 minutes to 10 minutes, between 10 minutes to I minute, or between 1 minute to 1 second.

13. The system of claim 11, wherein real-time is between 1 second to 100ms, between 100ms to 10ms, or between 10ms to 1ms.

14. The system of claim 1, wherein the one or more processors is further configured to accept updates, corrections, additions, deletions or combinations thereof to a pose of one or more sensor locations, and by retrieving and, if needed, altering a selection or projected location of the one or more anchor points as viewed with the at least one camera in the camera array, and optionally updates one or more sensor poses.

15. The system of claim 10, wherein, the one or more processors is further configured to accept updates, corrections, additions, deletions or combinations thereof to a pose of the one or more sensor locations along the sensor path, ranks a portion of the sensor poses along the sensor path, according to uncertainties in the poses; and
applies larger pose adjustments to those locations with the greatest uncertainty in pose, and smaller or no pose adjustments to locations with the least uncertainty in pose.

16.-33. (canceled)

34. The system of claims 2, wherein the system is further configured to use the determined pose changes to align two or more pairs of spatial information instances to generate an accumulated spatial information instance.

35. The system of claim 34, wherein the system is further configured to store the accumulated spatial information instance.

36. The system of claim 35, wherein temporal spatial information is accumulated geospatial temporal information.

37. The system of claim 36, wherein one or more poses in one or more spatial information instances is adjusted, based on further spatial or temporal spatial information becoming available, based on a degree of confidence associated with the one or more poses being adjusted.

38. The system of claim 37, wherein a sensor path comprises a series of pose changes determined by the one or more processors.

39. The system of 38, wherein the system is configured to continuously, or substantially continuously, accept additional data and/or data revisions in real-time or substantially real-time.

40. The system of claim 39, wherein the one or more processors is further configured to accept updates, corrections, additions, deletions or combinations thereof to the pose of one or more sensor locations, and by retrieving and, if needed, altering the selection or projected location of the one or more anchor points as viewed with the at least one camera in the camera array, and optionally updates one or more sensor poses.

41. The system of claim 39, wherein, the one or more processors is further configured to accept updates, corrections, additions, deletions or combinations thereof to the pose of the one or more sensor locations along the sensor path, ranks a portion of the sensor poses along the sensor path, according to the uncertainties in their pose; and applies larger pose adjustments to those locations with the greatest uncertainty in pose, and smaller or no pose adjustments to locations with the least uncertainty in pose.
